(19) United States
(12) Patent Application Publication
(10) Pub. No.: US 2016/0050494 A1
(43) Pub. Date: Feb. 18, 2016

(54) Portable Entertainment System

(71) Applicants: Coldtan McCorkle, Mahanttan, NY (US); Calvert Nurse, Mahanttan, NY (US)

(72) Inventors: Coldtan McCorkle, Mahanttan, NY (US); Calvert Nurse, Mahanttan, NY (US)

(21) Appl. No.: 14/825,025

(22) Filed: Aug. 12, 2015

Related U.S. Application Data
(60) Provisional application No. 62/036,373, filed on Aug. 12, 2014.

(51) Int. Cl. H04R 3/12; H04R 1/00

(52) U.S. Cl. CPC H04R 3/12; H04R 1/00

(57) ABSTRACT

A portable entertainment system that provides quality sound equipment and multiple entertainment interfaces has a first module and a second module that can be operated together or separately. The first module has a first console for running software and a first screen for displaying software interfaces. Additionally, the first module has a first mix on for mixing and editing music. Similarly, the second module has a second console for running software and a second screen for displaying software interfaces. Additionally, the second module has a second mix on for mixing and editing music. A docking station allows an electronic device to be connected for directly playing music through a pair of speakers that are removably attached to a main unit, such that the pair of speaker can be optimally positioned. The first screen and the second screen are similarly removably attached to the main unit offering remote viewing capabilities.

The current application claims a priority to the U.S. Provisional Patent application Ser. No. 62/036,373 filed on Aug. 12, 2014.

### FIELD OF THE INVENTION

The present invention relates generally to entertainment systems. More specifically, the present invention is a multi-functional, portable entertainment system that provides professional sound mixing equipment and multiple peripheral interfaces.

### BACKGROUND OF THE INVENTION

There are several types of disc jockeys (DJs), such as radio DJs, club DJs, and mobile DJs. The typical DJ utilizes a number of different devices to mix and play recorded music. Such equipment includes turntables, speakers, audio mixers, multiple sequencers, electronic effects units, computerized performance systems, and Musical Instrument Digital Interface (MIDI) controllers. Depending on the equipment needed, a DJs setup can cost an astronomical amount of money. This cost can also turn away those that do not have a lot of money but who are interested in becoming a DJ. Additionally, much of the equipment is rather large and cumbersome, making it difficult to transport the equipment from one venue to another.

Therefore it is the object of the present invention to provide a portable entertainment system that has a strong appeal for music lovers who wish to exercise not only their enjoyment and appreciation of music, but also their own creativity. The present invention is a portable music production studio that can be used to mix and edit music at home or DJ at a venue. The present invention is compact making it ideal for transportation and storage, and is self-contained, eliminating the need for amateur or professional DJs to cart massive volumes of equipment, compact discs, and other paraphernalia to gigs.

The present invention provides dual modules that can be used in unison or standalone, each module providing a console that can be used to run music mixing and editing software. Music can be downloaded onto each of the consoles through a number of different digital interfaces, such as MIDI connectors and universal serial bus connectors. Additionally, a docking station allows an electronic device such as a digital music player or smartphone to be docked, wherein music can be directly played from the electronic device. In this way, the present invention provides a premium quality, portable docking stereo system in addition to all the capabilities of sound-mixing and recording software that one would find in a music production studio.

Furthermore, the present invention provides additional entertainment functions that expands the use of the present invention and makes the present invention more appealing to a wider audience. Video games can be downloaded directly to each of the consoles or separate video game systems can be hooked up to and run through the consoles. In this way, the present invention provides dual entertainment value, as two separate video game systems can be hooked up at one time and used simultaneously. Alternatively, one console can be used for video games, while the other console is used for mixing and editing music.

### BRIEF DESCRIPTION OF THE DRAWINGS

FIG. 1 is a perspective view of the present invention, wherein the first screen and the second screen are in the open position, the pair of speakers is in the upright position, and the stand is unfolded; and

FIG. 2 is a perspective view thereof, wherein the disc trays are open.

FIG. 3 is a perspective view of the present invention, wherein the first screen, the second screen, and the pair of speakers are detached from the main unit.

FIG. 4 is a perspective view of the present invention, wherein the first screen, the second screen, and the pair of speakers are in the folded position, and wherein the stand is folded.

FIG. 5 is a top plan view, wherein the first screen and the second screen are in the open position, and the pair of speakers is in the upright position.

FIG. 6 is a top plan view, wherein the first screen, the second screen, and the pair of speakers are in the folded position.

FIG. 7 is a rear elevational view, wherein the first screen and the second screen are in the open position, and the pair of speakers is in the upright position.

FIG. 8 is a rear elevational view, wherein the first screen, the second screen, and the pair of speakers are in the folded position.

FIG. 9 is a right side elevational view showing the first plurality of digital interfaces.

FIG. 10 is a left side elevational view showing the second plurality of digital interfaces.

FIG. 11 is a top plan view of the remote control in the watch configuration.

FIG. 12 is a diagram showing the electronic connections of the first console, wherein the first console transceiver is communicably coupled to the first screen transceiver and the speaker transceiver of each of the pair of speakers.

FIG. 13 is a diagram showing the electronic connections of the second console, wherein the second console transceiver is communicably coupled to the second screen transceiver and the speaker transceiver of each of the pair of speakers.

FIG. 14 is a diagram wherein the first console transceiver is communicably coupled to the peripheral transceiver of a peripheral being headphones, and the second console transceiver is communicably coupled to the peripheral transceiver of a peripheral being a microphone.

FIG. 15 is a diagram wherein the remote transceiver is communicably coupled to both the first console transceiver and the second console transceiver.

### DETAIL DESCRIPTIONS OF THE INVENTION

All illustrations of the drawings are for the purpose of describing selected versions of the present invention and are not intended to limit the scope of the present invention.

The present invention is a multi-functional, portable entertainment system that provides disc jockey (DJ) quality sound equipment and multiple entertainment interfaces. The present invention combines, in one portable and modular unit, aspects of both a premium-quality docking digital stereo, and sophisticated yet user-friendly, digital sound-editing software and techniques. The design intent is to provide consumers a high-quality, self-contained sound system, not only for sharing the content of their personal music players but for mixing, editing, revising, and combining said content in new and exciting ways: a sort of portable music-production studio. Furthermore, the present invention provides built-in computer entertainment functions in addition to interfaces for other entertainment sources such as digital music players, smartphones, and video game consoles.

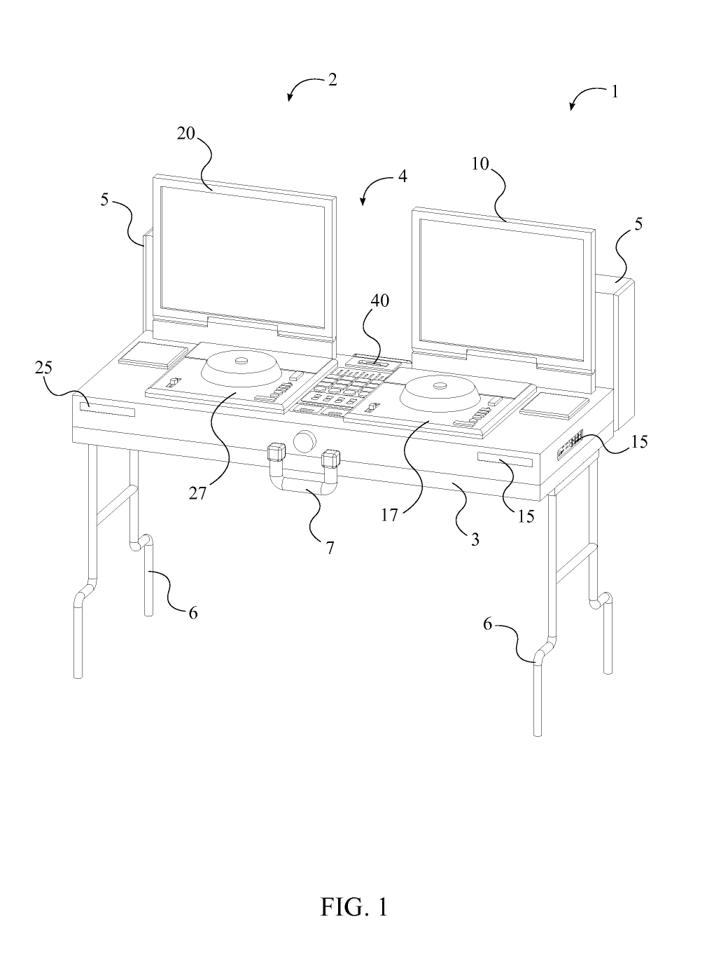

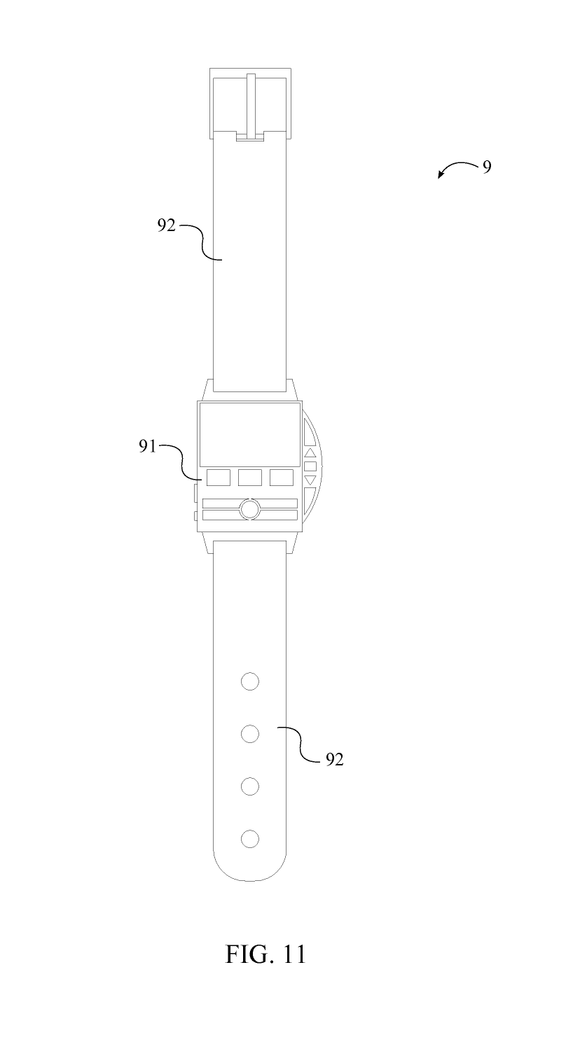

In reference to FIG. 1 and FIG. 11, the present invention comprises a main unit 3, a first module 1, a second module 2, a docking station 4, a pair of speakers 5, and a remote control 9. The main unit 3 is the housing into which the first module 1, the second module 2, and the docking station 4 are integrated and to which the pair of speakers 5 is removably attached. Both the first module 1 and the second module 2 provide independent entertainment architectures that can be used for a variety of entertainment purposes, including but not limited to, playing music, mixing music, recording music, playing video games, and playing movies. The docking station 4 allows a user to connect a digital music player, smartphone, or similar electronic device to the present invention, in order to play digital media, such as music and movies, from the connected device.

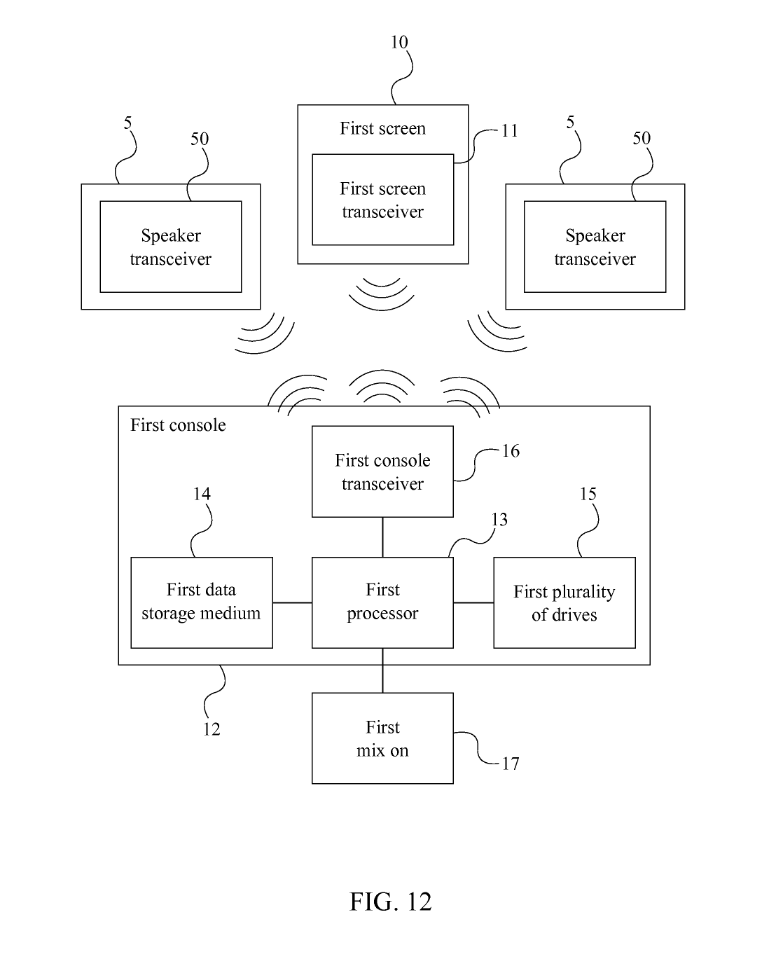

In reference to FIG. 1 and FIG. 12, the first module 1 comprises a first screen 10, a first console 12, and a first mix on 17. The first console 12 provides the necessary computing infrastructure for running various programs, such as music mixing and editing software, and video games. Furthermore, the first console 12 can be configured to run various operating systems; having either one or multiple installed operating systems. Such software and operating systems may be unique to the present invention, or may be developed by third parties and adapted to the present invention. The first screen 10 is used to display user interfaces of the software programs and operating systems installed on the first console 12. The first mix on 17 provides a physical DJ interface for mixing music, either standalone or in conjunction with software installed on the first console 12.

In reference to FIG. 12, the first console 12 comprises a first processor 13, a first data storage medium 14, and a first plurality of digital interfaces 15, and a first console transceiver 16. The first processor 13 is able to run software stored on the first data storage medium 14 or external devices connected to the first plurality of digital interfaces 15, interpret digital input signals through the first screen 10 and the first mix on 17, and process digital data received through the first plurality of digital interfaces 15 and the docking station 4. As such, the first data storage medium 14 and the first plurality of digital interfaces 15 are electronically connected to the first processor 13. Furthermore, the first console transceiver 16 is electronically connected to the first processor 13 in order to relay digital signals between the first processor 13 and other devices, such as the first screen 10. The first processor 13 may be a single processor, or multiple homogenous or heterogeneous processors.

The first data storage medium 14 can be any type of memory device used to store digital data, such as a hard disk drive or a solid state drive. The first data storage medium 14 can provide primary memory, secondary memory, or a combination of both primary memory and secondary memory. The first data storage medium 14 allows software programs, operating systems, and digital data such as audio files to be stored on the first console 12. The first console 12 can utilize a single operating system, or multiple operating systems, wherein the user can choose the operating system upon turning on the first console 12. In the preferred embodiment of the present invention, the first data storage medium 14 is used to store libraries of drum beats, bass-lines, and other instrumental and vocal tracks. Such digital data can come preloaded on the first data storage medium 14, or the digital data can be downloaded or added to at a later time.

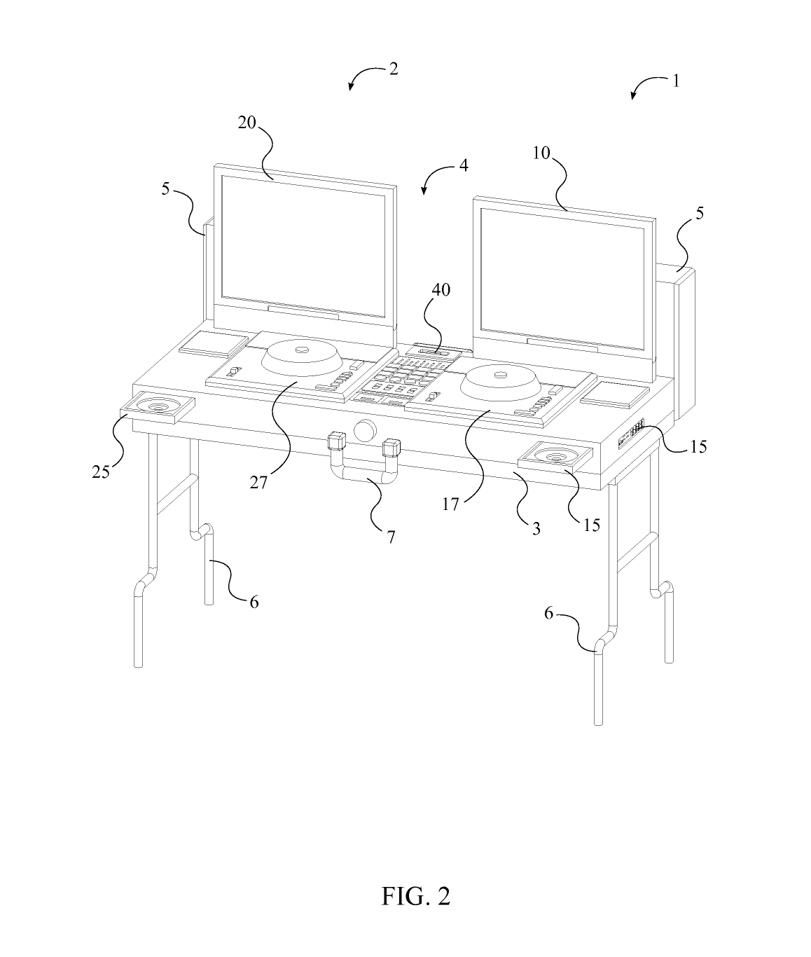

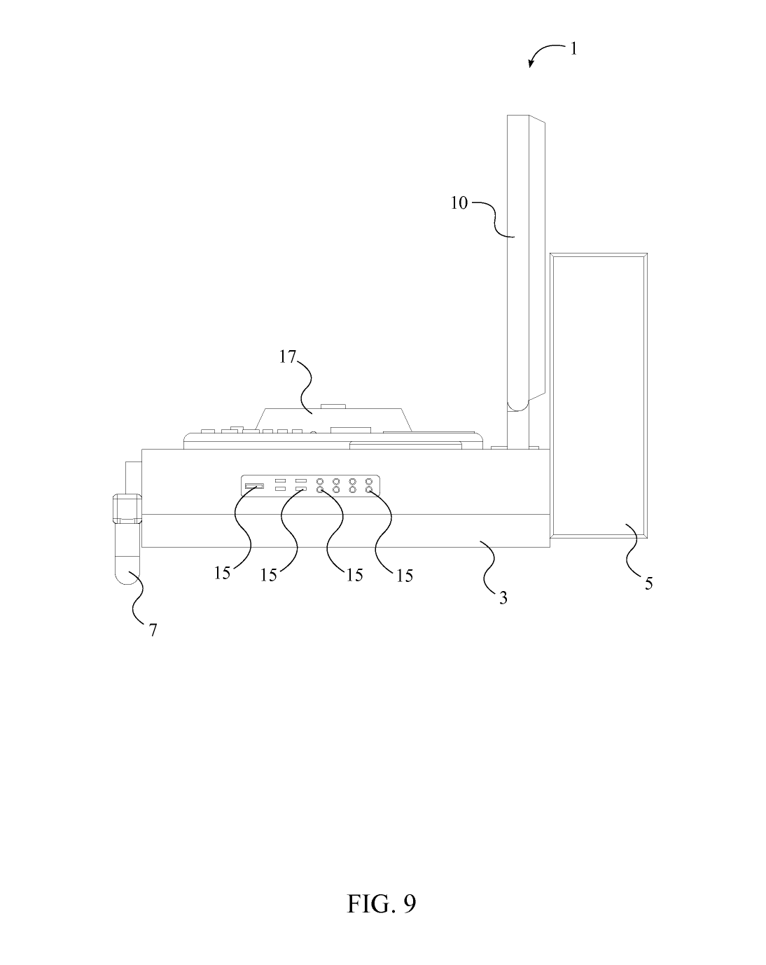

In reference to FIG. 2 and FIG. 9, the first plurality of digital interfaces 15 allows the first processor 13 and the first data storage medium 14 to receive digital signals and digital data from a number of different external devices. In the preferred embodiment of the present invention, the first plurality of digital interfaces 15 includes a compact disc (CD)/digital versatile disc (DVD) drive, universal serial bus (USB) connectors, video signal inputs, audio signal inputs, and audio signal outputs. The CD/DVD drive allows music to be played or downloaded from a CD, DVD, or mini disc; the USB connectors allow digital files to be downloaded from a USB flash drive; the video signal inputs provide video inputs for video game consoles; the audio signal inputs provide audio inputs for video games consoles, microphones, and musical instruments; and the audio signal outputs provide audio outputs for headphones and speakers. It is also possible for the first plurality of digital interfaces 15 to include any number of other interface types in other embodiments of the present invention.

The first console 12 is also Musical Instrument Digital Interface (MIDI) compatible. The first processor 13 and the first data storage medium 14 are configured to interpret MIDI files and create MIDI files. Furthermore, the first data storage medium 14 stores MIDI software such as sequencers, notation/scoring software, editors/librarians, and auto-accompaniment programs, wherein the first processor 13 is able to run the MIDI software. Meanwhile, the first plurality of digital interfaces 15 provides the appropriate MIDI connectors, allowing instruments and MIDI devices to be connected to the first console 12.

In reference to FIG. 1 and FIG. 12, the first mix on 17 is adjacently connected to the main unit 3, being positioned on the top of the main unit 3 and is electronically connected to the first console 12 (more specifically, the first processor 13). In the preferred embodiment of the present invention, the mix on provides a compact disc jockey (CDJ) that allows a user to manually manipulate music that is being played through the first console 12. More particularly, the CDJ allows the user to emulate the vinyl scratching of traditional turntables. In other embodiments of the present invention, the first mix on 17 may provide a traditional turntable in place of the CDJ. The first mix on 17 may further provide physical controls for manipulating the music played through the first console 12. Such physical controls may include, but are not limited to, a crossfader, a pitch control, and a tone control.

In reference to FIG. 1, the first screen 10 is positioned adjacent to the first mix on 17, on top of the main unit 3, and provides a visual display of the software being run on the first console 12. In the preferred embodiment of the present invention, the first screen 10 is a touchscreen, wherein the user can interact with the first console 12 through virtual controls. For example, if the user is using a music mixing and editing software, then the first screen 10 can be used to display a full soundboard with on-screen, virtual mixing slides to fine-tune audio quality. As another example, the first screen 10 can be used to play a video game run through the first console 12 that requires touchscreen inputs.

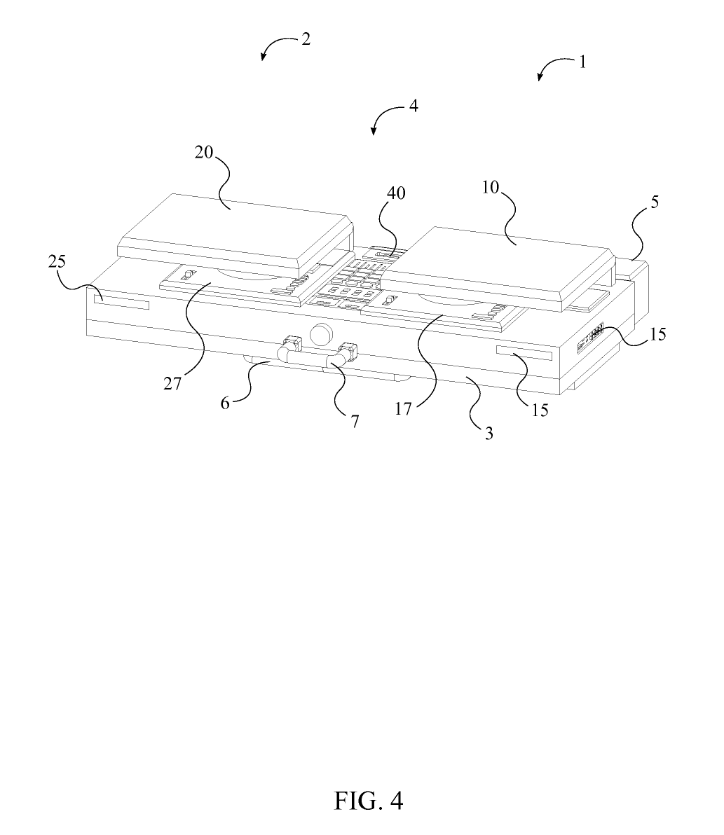

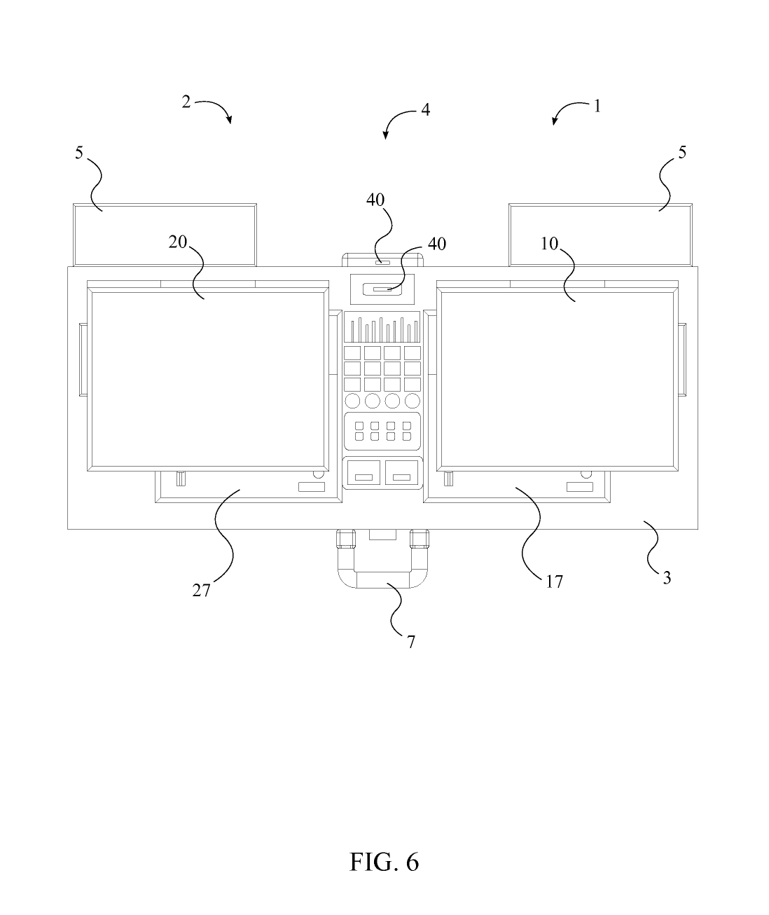

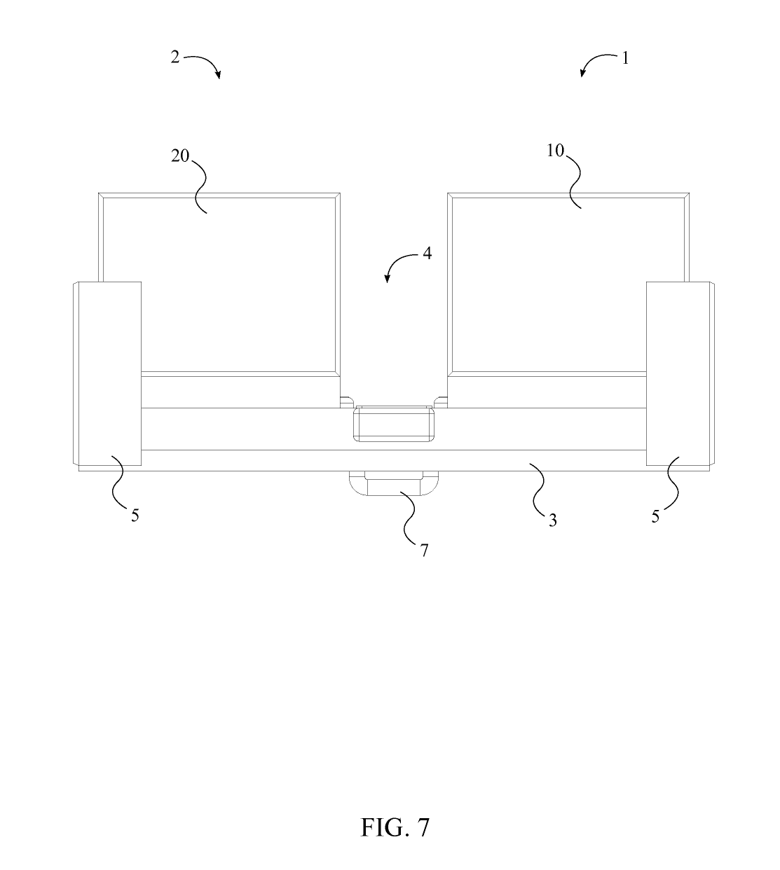

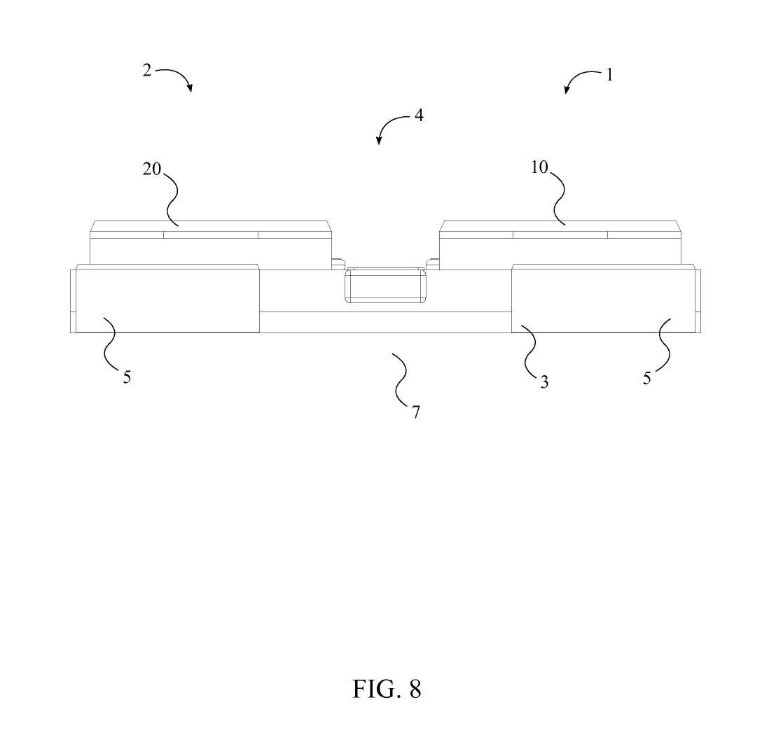

The first screen 10 is bistably attached to the main unit 3, wherein the first screen 10 can be positioned in a folded position and an open position. More specifically, the first screen 10 is hingedly attached to the main unit 3 to facilitate the transition between the folded position and the open position. The folded position of the first screen 10, as depicted in FIGS. 4, 6, and 8, allows the present invention to be more easily transported and stored. Conversely, the open position of the first screen 10, as depicted in FIGS. 1, 5, and 7, allows the user to interact with the first screen 10 when the present invention is in use.

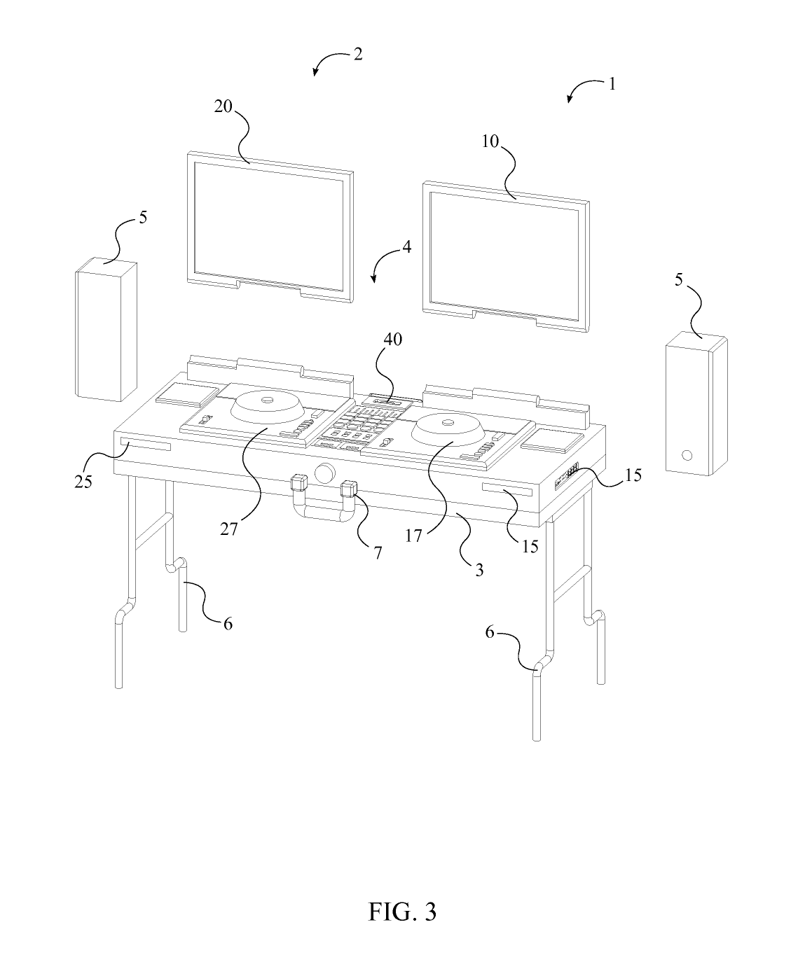

Furthermore and in reference to FIG. 3, the first screen 10 is removably attached to the main unit 3, wherein the first screen 10 can be repositioned in a remote location away from the main unit 3. For example, if the second module 2 is also in use, then the user may wish to place the first screen 10 on a stand that is separated away from the main unit 3. In order to allow for the remote positioning of the first screen 10, the first console 12 is communicably coupled to the first screen 10. More specifically and in reference to FIG. 12, the first screen 10 comprises a first screen transceiver 11, wherein the first console transceiver 16 is communicably coupled to the first screen transceiver 11. The first console transceiver 16 and the first screen transceiver 11 can use any type of wireless standard in order to communicate with each other.

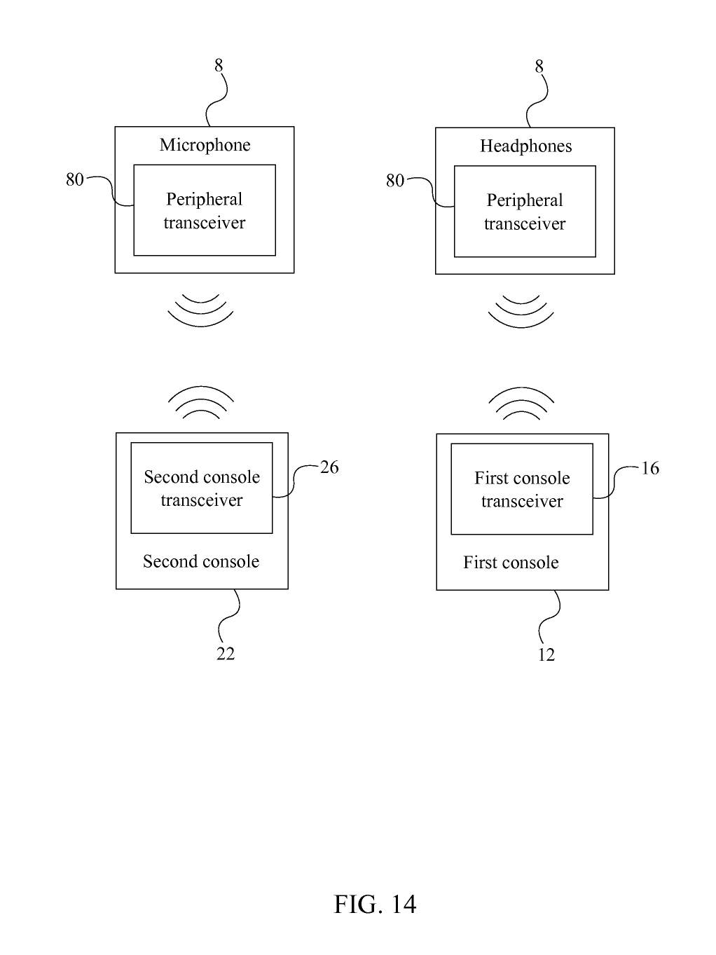

In reference to FIG. 14, the first console transceiver 16 can also be communicably coupled to a peripheral 8, such as a wireless microphone, wireless headphones, or a wireless headset having both a microphone and headphone. In order to communicate with the first console transceiver 16, the peripheral 8 comprises a peripheral transceiver 80, wherein the first console transceiver 16 is communicably coupled to the peripheral transceiver 80. The first console transceiver 16 and the peripheral transceiver 80 can use any type of wireless standard in order to communicate with each other. The use of the peripheral 8 with the peripheral transceiver 80 allows the user to communicate with the first console 12 by either sending or receiving digital signals from a remote location, away from the main unit 3. This also removes the hassle of having many wires attached to the main unit 3.

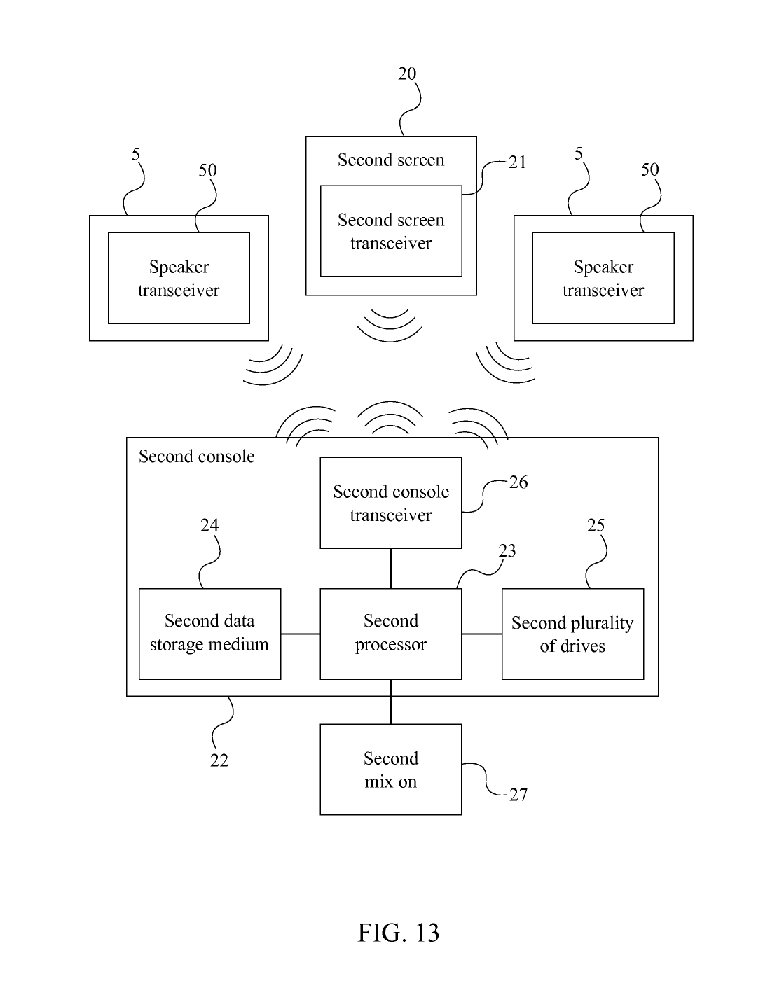

In reference to FIG. 1 and FIG. 13, the second module 2 comprises a second screen 20, a second console 22, and a second mix on 27. The second console 22 provides the necessary computing infrastructure for running various programs, such as music mixing and editing software, and video games. Furthermore, the second console 22 can be configured to run various operating systems; having either one or multiple installed operating systems. Such software and operating systems may be unique to the present invention, or may be developed by third parties and adapted to the present invention. The second screen 20 is used to display user interfaces of the software programs and operating systems installed on the second console 22. The second mix on 27 provides a physical DJ interface for mixing music, either standalone or in conjunction with software installed on the second console 22.

In reference to FIG. 13, the second console 22 comprises a second processor 23, a second data storage medium 24, and a second plurality of digital interfaces 25, and a second console transceiver 26. The second processor 23 is able to run software stored on the second data storage medium 24 or external devices connected to the second plurality of digital interfaces 25, interpret digital input signals through the second screen 20 and the second mix on 27, and process digital data received through the second plurality of digital interfaces 25 and the docking station 4. As such, the second data storage medium 24 and the second plurality of digital interfaces 25 are electronically connected to the second processor 23. Furthermore, the second console transceiver 26 is electronically connected to the second processor 23 in order to relay digital signals between the second processor 23 and other devices, such as the second screen 20. The second processor 23 may be a single processor, or multiple homogenous or heterogeneous processors.

The second data storage medium 24 can be any type of memory device used to store digital data, such as a hard disk drive or a solid state drive. The second data storage medium 24 can provide primary memory, secondary memory, or a combination of both primary memory and secondary memory. The second data storage medium 24 allows software programs, operating systems, and digital data such as audio files to be stored on the second console 22. The second console 22 can utilize a single operating system, or multiple operating systems, wherein the user can choose the operating system upon turning on the second console 22. In the preferred embodiment of the present invention, the second data storage medium 24 is used to store libraries of drum beats, bass-lines, and other instrumental and vocal tracks. Such digital data can come preloaded on the second data storage medium 24, or the digital data can be downloaded or added to at a later time.

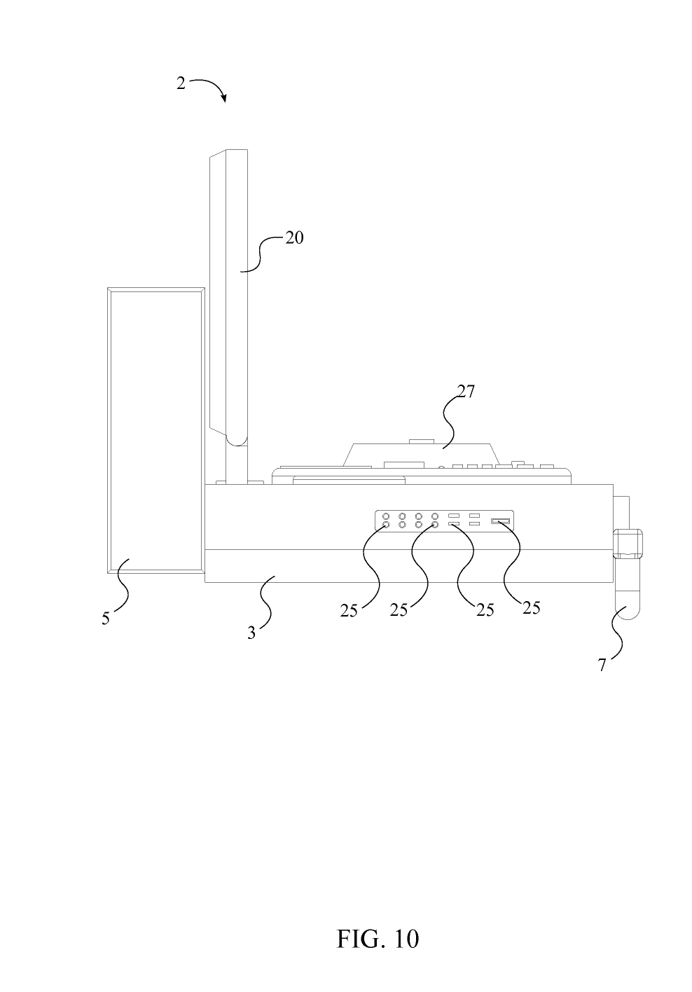

In reference to FIG. 2 and FIG. 10, the second plurality of digital interfaces 25 allows the second processor 23 and the second data storage medium 24 to receive digital signals and digital data from a number of different external devices. In the preferred embodiment of the present invention, the second plurality of digital interfaces 25 includes a CD/DVD drive, universal serial bus USB connectors, video signal inputs, audio signal inputs, and audio signal outputs. The CD/DVD drive allows music to be played or downloaded from a CD, DVD, or mini disc; the USB connectors allow digital files to be downloaded from a USB flash drive; the video signal inputs provide video inputs for video game consoles; the audio signal inputs provide audio inputs for video games consoles, microphones, and musical instruments; and the audio signal outputs provide audio outputs for headphones and speakers. It is also possible for the second plurality of digital interfaces 25 to include any number of other interface types in other embodiments of the present invention.

The second console 22 is also MIDI compatible. The second processor 23 and the second data storage medium 24 are configured to interpret MIDI files and create MIDI files. Furthermore, the second data storage medium 24 stores MIDI software such as sequencers, notation/scoring software, editors/librarians, and auto-accompaniment programs, wherein the second processor 23 is able to run the MIDI software. Meanwhile, the second plurality of digital interfaces 25 provides the appropriate MIDI connectors, allowing instruments and MIDI devices to be connected to the second console 22.

In reference to FIG. 1 and FIG. 13, the second mix on 27 is adjacently connected to the main unit 3, being positioned on the top of the main unit 3 and is electronically connected to the second console 22 (more specifically, the second processor 23). In the preferred embodiment of the present invention, the mix on provides a CDJ that allows a user to manually manipulate music that is being played through the second console 22. More particularly, the CDJ allows the user to emulate the vinyl scratching of traditional turntables. In other embodiments of the present invention, the second mix on 27 may provide a traditional turntable in place of the CDJ. The second mix on 27 may further provide physical controls for manipulating the music played through the second console 22. Such physical controls may include, but are not limited to, a crossfader, a pitch control, and a tone control.

In reference to FIG. 1, the second screen 20 is positioned adjacent to the second mix on 27, on top of the main unit 3, and provides a visual display of the software being run on the second console 22. In the preferred embodiment of the present invention, the second screen 20 is a touchscreen, wherein the user can interact with the second console 22 through virtual controls. For example, if the user is using a music mixing and editing software, then the second screen 20 can be used to display a full soundboard with on-screen, virtual mixing slides to fine-tune audio quality. As another example, the second screen 20 can be used to play a video game run through the second console 22 that requires touchscreen inputs.

The second screen 20 is bistably attached to the main unit 3, wherein the second screen 20 can be positioned in a folded position and an open position. More specifically, the second screen 20 is hingedly attached to the main unit 3 to facilitate the transition between the folded position and the open position. The folded position of the second screen 20, as depicted in FIGS. 4, 6, and 8, allows the present invention to be more easily transported and stored. Conversely, the open position of the second screen 20, as depicted in FIGS. 1, 5, and 7, allows the user to interact with the second screen 20 when the present invention is in use.

Furthermore and in reference to FIG. 3, the second screen 20 is removably attached to the main unit 3, wherein the second screen 20 can be repositioned in a remote location away from the main unit 3. For example, if the first module 1 is also in use, then the user may wish to place the second screen 20 on a stand that is separated away from the main unit 3. In order to allow for the remote positioning of the second screen 20, the second console 22 is communicably coupled to the second screen 20. More specifically and in reference to FIG. 13, the second screen 20 comprises a second screen transceiver 21, wherein the second console transceiver 26 is communicably coupled to the second screen transceiver 21. The second console transceiver 26 and the second screen transceiver 21 can use any type of wireless standard in order to communicate with each other.

In reference to FIG. 14, the second console transceiver 26 can also be communicably coupled to a peripheral 8, such as a wireless microphone, wireless headphones, or a wireless headset having both a microphone and headphone. In order to communicate with the second console transceiver 26, the peripheral 8 comprises a peripheral transceiver 80, wherein the second console transceiver 26 is communicably coupled to the peripheral transceiver 80. The second console transceiver 26 and the peripheral transceiver 80 can use any type of wireless standard in order to communicate with each other. The use of the peripheral 8 with the peripheral transceiver 80 allows the user to communicate with the second console 22 by either sending or receiving digital signals from a remote location, away from the main unit 3. This also removes the hassle of having many wires attached to the main unit 3.

The first module 1 and the second module 2 can be operated independently of each other, allowing one or more users to use the first module 1 and the second module 2 for separate applications. For example, one user may use the first module 1 with a first video game system, while another user uses the second module 2 with a second video game system. As another example, one user may use a music mixing and editing software on the first module 1, while another user plays a video game directly from the second module 2. While the first module 1 and the second module 2 are designed for independent use, the first module 1 and the second module 2 may also be used together for certain applications. For example, mixing and sampling music may require the use of the first mix on 17 and the second mix on 27, while the music mixing and editing software is run on either the first console 12 or the second console 22.

Furthermore, the first console 12 and the second console 22 may be used with the same or different operating systems. The operating systems may be uniquely designed for the present invention, such as a unique mixer operating system for music mixing/composing, or the operating system may be used with any third party operating system. In this way, the present invention can be universally used with any operating system.

Power can be supplied to the first console 12 and the second console 22 through either a cable and plug or from a battery. If a cable and plug are used, then the main unit 3 comprises a plug compartment, wherein the cable and the plug can be retracted into the main unit 3 for each storage when the present invention is not in use. If a battery is used to power the first console 12 and the second console 22, then the battery is ideally rechargeable, wherein the main unit 3 comprises a charging port through which the battery can be charged.

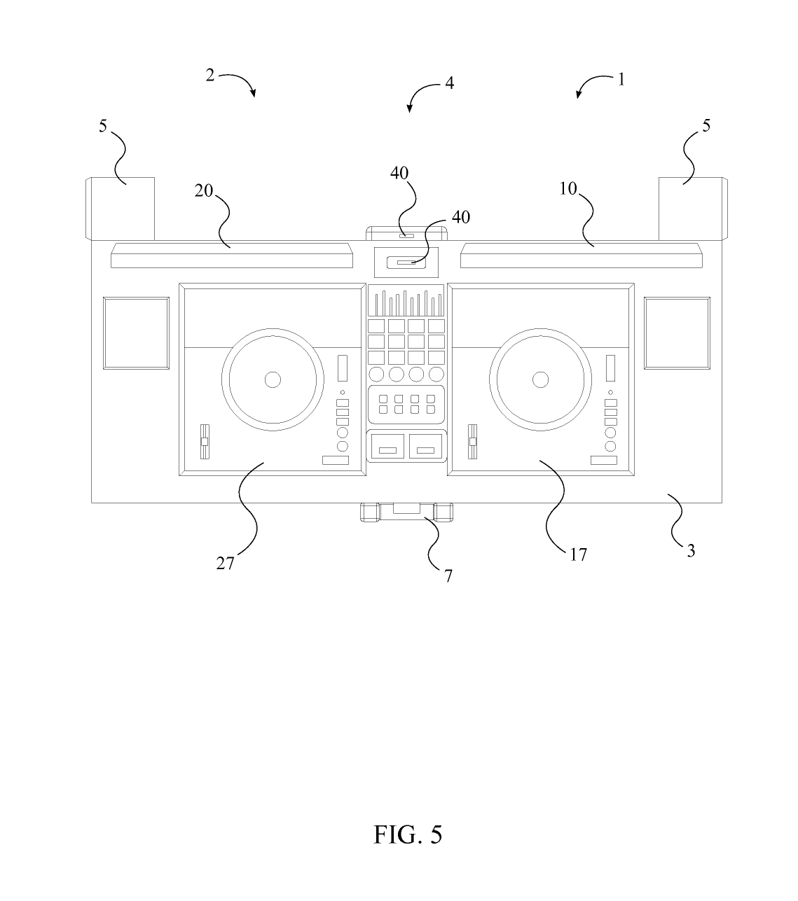

In reference to FIG. 1 and FIG. 5, the docking station 4 is integrated into the main unit 3 and is positioned in between the first mix on 17 and the second mix on 27. Furthermore, the docking station 4 is electronically connected to the first console 12 and the second console 22. The docking station 4 allows the user to connect one or more electronic devices, such as a digital music player or smartphone, to the present invention in order to download music from or directly play music from the electronic devices. The docking station 4 comprises an at least one digital dock 40 that is positioned into the main unit 3; the at least one digital dock 40 being electrically connected to both the first console 12 and the second console 22.

The desired electronic device is attached to the at least one digital dock 40, wherein the desired electronic device is electronically connected to either the first console 12 or the second console 22. Each of the at least one digital dock 40 may be designed for a particular electronic device, or a plurality of adapters can be provided, allowing each of the at least one digital dock 40 to be used with multiple types of electronic devices. Each of the at least one digital dock 40 may be electronically connected to both the first console 12 and the second console 22, or each of the at least one digital dock 40 may be electronically connected to either the first console 12 or the second console 22.

In reference to FIG. 5, the pair of speakers 5 is adjacently attached to the main unit 3, wherein each of the pair of speakers 5 is positioned opposite each other along the main unit 3. In the preferred embodiment of the present invention, the pair of speakers 5 is perimetrically attached to the main unit 3, wherein the pair of speakers 5 is positioned on the back side of the present invention. The pair of speakers 5 allows the user to play music directly from the present invention, wherein the pair of speakers 5 is removably attached to the main unit 3 as depicted by FIG. 2-3, such that each of the pair of speakers 5 can be optimally positioned according to the situation and environment in which the present invention is being used. This allows each of the pair of speakers 5 to be optimally positioned/angled in relation to the audience or the user themselves.

Similar to the first screen 10 and the second screen 20, the pair of speakers 5 is bistably attached to the main unit 3, wherein each of the pair of speakers 5 can be moved between a folded position and an upright position. More specifically, each of the pair of speakers 5 is pivotally attached to the main unit 3 to facilitate the transition between the folded position and the upright position. The folded position of the pair of speakers 5, as depicted in FIGS. 4, 6, and 8, allows the present invention to be more easily transported and stored. Conversely, the upright position of the pair of speakers 5, as depicted in FIGS. 1, 5, and 7, is more conducive to directing sound waves when the present invention is in use.

In reference to FIG. 12-13, each of the pair of speakers 5 can be communicably coupled to either the first console 12 or the second console 22. As such, each of the pair of speakers 5 comprises a speaker transceiver 50, wherein the speaker transceiver 50 of each of the pair of speakers 5 is communicably coupled to either the first console transceiver 16 or the second console transceiver 26. When the pair of speakers 5 is communicably coupled to the first console 12 headphones or additional speakers can be connected to the second console 22 via either the second console transceiver 26 or the second plurality of digital interfaces 25. Similarly, when the pair of speakers 5 is communicably coupled to the second console 22 headphones or additional speakers can be connected to the first console 12 via either the first console transceiver 16 or the first plurality of digital interfaces 15.

It is also possible for both the first console 12 and the second console 22 to be communicably coupled if both the first console 12 and the second console 22 are being used in unison. In other embodiments of the present invention, it may also be possible for the first console 12 to be communicably coupled to one of the pair of speakers 5, while the second console 22 is communicably coupled to the other speaker from the pair of speakers 5. In this way, both the first console 12 and the second console 22 are communicably coupled to one speaker, allowing each of the pair of speakers 5 to be used for separate applications. The first console transceiver 16 and the speaker transceiver 50 can use any type of wireless standard in order to communicate with each other. Similarly, the second console transceiver 26 and the speaker transceiver 50 can use any type of wireless standard in order to communicate with each other.

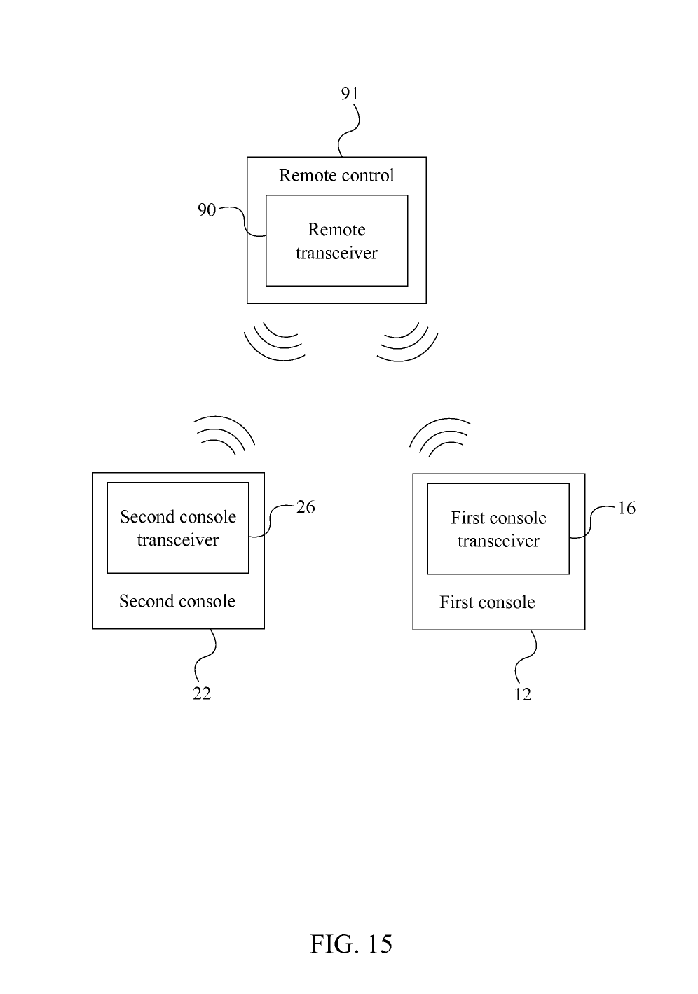

In reference to FIG. 11 and FIG. 15, the remote control 9 allows the user to control certain functions of the first console 12 and the second console 22 from a remote location away from the main unit 3. The remote control 9 is used to control simple functions of the first console 12 and the second console 22 such as selecting and playing tracks, controlling volume, pausing the music. The remote control 9 is not used for not complex functions such as performing mixing operations and editing music. In order to communicate and control the first console 12 and the second console 22, the remote control 9 comprises a remote transceiver 90. The remote transceiver 90 is communicably coupled to both the first console transceiver 16 and the second console transceiver 26 in order to control the first console 12 and the second console 22 respectively. The remote control 9 may be used to control both the first console 12 and the second console 22 at the same time, or the remote control 9 may allow the user to switch between controlling the first console 12 and the second console 22. The first console transceiver 16 and the second console transceiver 26 can use any type of wireless standard in order to communicate with the remote transceiver 90.

In the preferred embodiment of the present invention, the remote control 9 is configured as a watch, wherein the remote control 9 comprises a body 91 and a strap 92 as depicted in FIG. 11. The remote transceiver 90 is positioned within the body 91, wherein the body 91 provides controls, allowing the user to input commands for controlling the first console 12 or the second console 22. The controls may be provided in the form of physical buttons or a touchscreen. The strap 92 is terminally connected to the body 91, wherein the strap 92 allows the body 91 to be attached to the wrist of the user. The strap 92 may be a single piece that is flexible and stretchable in order to be fitted around the wrist of the user, or the strap 92 may be two pieces, wherein the two pieces are connected to each other by a clasp or other fastening mechanism.

Furthermore, in the preferred embodiment of the present invention, the remote control 9 is battery powered. The remote control 9 has a rechargeable battery that powers the remote transceiver 90 and the controls, and a charging port through which the rechargeable battery is charged. In other embodiments of the present invention the rechargeable battery may be charged wirelessly without the need for the charging port. In yet other embodiments of the present invention, the battery may be a single use battery, wherein an access panel is provided in the body 91 of the remote control 9, allowing the battery to be replaced.

The present invention further comprises a stand 6 and a handle 7. The stand 6 is adjacently connected to the main unit 3 opposite the first mix on 17 and the second mix on 27, wherein the stand 6 allows the main unit 3 to raised upright for operation on location. In the preferred embodiment of the present invention, the stand 6 is a trestle style and is hingedly connected to the main unit 3, wherein the stand 6 can easily be folded up in order to easily transport and store the present invention, as depicted by FIG. 1 and FIG. 4. Meanwhile, the handle 7 is perimetrically connected to the main unit 3, wherein the handle 7 allows the present invention to be easily lifted and transported as depicted in FIG. 4. Similar to the stand 6, the handle 7 is preferably hingedly connected to the main unit 3, allowing the handle 7 to be folded down and out of the way when the present invention is in use as depicted in FIG. 1.

The portable entertainment system is also designed to be communicably coupled with a subsequent portable entertainment system. In this way, information can be shared between the portable entertainment system and the subsequent portable entertainment system. This effectively doubles the number of speakers and screens that can be utilized by the user. The portable entertainment system and the subsequent portable entertainment system can be communicably coupled to each other using any wireless communication standard. Alternatively, the portable entertainment system and the subsequent portable entertainment system can be communicably coupled using a wired connection.

Although the invention has been explained in relation to its preferred embodiment, it is to be understood that many other possible modifications and variations can be made without departing from the spirit and scope of the invention as hereinafter claimed.

What is claimed is:

1. A portable entertainment system comprises:
a first module comprises a first screen, a first console, and a first mix on;
a second module comprises a second screen, a second console, and a second mix on;
the first mix on and the second mix on being adjacently connected to a main unit;
a docking station being positioned in between the first mix on and the second mix on;
the docking station being electronically connected to the first console and the second console;
the first mix on being electronically connected to the first console;
the second mix on being electronically connected to the second console;
the first screen being communicably coupled to the first console;
the second screen being communicably coupled to the second console;
the first screen, the second screen, and a pair of speakers being adjacently attached to the main unit;
each of the pair of speakers being positioned opposite each other along the main unit;
the first mix on being positioned adjacent to the first screen; and
the second mix on being positioned adjacent to the second screen.

2. The portable entertainment system as claimed in claim 1 comprises:
the first console comprises a first console transceiver;
each of the pair of speakers comprises a speaker transceiver; and
the first console transceiver being communicably coupled to the speaker transceiver of each of the pair of speakers.

3. The portable entertainment system as claimed in claim 1 comprises:
the second console comprises a second console transceiver;
each of the pair of speakers comprises a speaker transceiver; and
the second console transceiver being communicably coupled to the speaker transceiver of each of the pair of speakers.

4. The portable entertainment system as claimed in claim 1 comprises:
the first console comprises a first processor, a first data storage medium, and a first plurality of digital interfaces; and
each of the first plurality of digital interfaces and the first data storage medium being electronically connected to the first processor.

5. The portable entertainment system as claimed in claim 1 comprises:
the second console comprises a second processor, a second data storage medium, and a second plurality of digital interfaces; and
each of the second plurality of digital interfaces and the second data storage medium being electronically connected to the second processor.

6. The portable entertainment system as claimed in claim 1 comprises:
the first screen comprises a first screen transceiver;
the first console comprises a first console transceiver; and
the first console transceiver being communicably coupled to the first screen transceiver.

7. The portable entertainment system as claimed in claim 1 comprises:
the second screen comprises a second screen transceiver;
the second console comprises a second console transceiver; and
the second console transceiver being communicably coupled to the second screen transceiver.

8. The portable entertainment system as claimed in claim 1 comprises:
the docking station comprises an at least one digital dock;
the at least one digital dock being positioned into the main unit; and
the at least one digital dock being electronically connected to both the first console and the second console.

9. The portable entertainment system as claimed in claim 1, wherein both the first screen and the second screen are a touchscreen.

10. The portable entertainment system as claimed in claim 1 comprises:
the first screen and the second screen being bistably attached to the main unit.

11. The portable entertainment system as claimed in claim 1 comprises:
the first screen and the second screen being hingedly attached to the main unit.

12. The portable entertainment system as claimed in claim 1 comprises:
each of the pair of speakers being bistably attached to the main unit.

13. The portable entertainment system as claimed in claim 1 comprises:
each of the pair of speakers being pivotally attached to the main unit.

14. The portable entertainment system as claimed in claim 1 comprises:
a stand; and
the stand being adjacently connected to the main unit opposite the first mix on and the second mix on.

15. The portable entertainment system as claimed in claim 14 comprises:
the stand being hingedly connected to the main unit.

16. The portable entertainment system as claimed in claim 1 comprises:
a handle; and
the handle being perimetrically connected to the main unit.

17. The portable entertainment system as claimed in claim 1 comprises:
a peripheral comprises a peripheral transceiver;
the first console comprises a first console transceiver; and
the first console transceiver being communicably coupled to the peripheral transceiver.

18. The portable entertainment system as claimed in claim 1 comprises:
a peripheral comprises a peripheral transceiver;
the second console comprises a second console transceiver; and
the second console transceiver being communicably coupled to the peripheral transceiver.

19. The portable entertainment system as claimed in claim 1 comprises:
a remote control comprises a remote transceiver;
the first console comprises a first console transceiver;
the second console comprises a second console transceiver; and
the remote transceiver being communicably coupled to both the first console transceiver and the second console transceiver.

20. The portable entertainment system as claimed in claim 19 comprises:
the remote control further comprises a body and a strap;
the remote transceiver being positioned within the body; and
the strap being terminally connected to the body.
